(19) United States
(12) Patent Application Publication
(10) Pub. No.: US 2002/0188061 A1
(43) Pub. Date: Dec. 12, 2002

(54) Polyurethanes and their use for the thickening of aqueous system

(76) Inventors: Christian Wamprecht, Neuss (DE); Jan Mazanek, Koln (DE); Peter Manshausen, Koln (DE); Frank Sauer, Langenfeld (DE)

Correspondence Address: BAYER CORPORATION, PATENT DEPARTMENT, 100 BAYER ROAD, PITTSBURGH, PA, 15205, US

(21) Appl. No.: 10/092,077

(22) Filed: Mar. 6, 2002

(30) Foreign Application Priority Data
Mar. 12, 2001 (DE) 10111794.9

(51) Int. Cl. C08K 3/00

(52) U.S. Cl. 524/589

(57) ABSTRACT

The invention relates to water-soluble or water-dispersible polyurethane comprising a reaction product of

A) a mixture of at least one polyether polyol a1) having an average functionality of ≧3 and at least one urethane group-containing polyether polyol a2) having an average functionality of ≧4,

B) at least one monoisocyanate having 8 to 22 carbon atoms,

C) at least one (cyclo)aliphatic and/or aromatic diisocyanate,

D) optionally at least one monoalcohol having 8 to 22 carbon atoms, and

G) optionally at least one polyisocyanate having an average functionality of >2

wherein the starting NCO/OH equivalent ratio is between 0.5:1 to 1.2:1 and which are suitable as thickening agents for aqueous systems, having a particularly efficient thickening action, a process for their production and aqueous systems containing them.

### BACKGROUND OF THE INVENTION

The present invention relates to a hydrophilic/hydrophobic water-soluble or water-dispersible polyurethane suitable as a thickening agent for aqueous systems having a particularly efficient thickening effect, as well as their use for the thickening of aqueous systems.

Polyurethane-based thickening agents for aqueous systems are described in numerous publications, (see for example DE-A 1 444 243, DE-A 3 630 319, EP-A-0 031 777, EP-A-0 307 775, EP-A-0 495 373, U.S. Pat. No. 4,079,028, U.S. Pat. No. 4,155,892, U.S. Pat. No. 4,499,233 or U.S. Pat. No. 5,023,309).

A common feature of these thickening agents belonging to the prior art is the simultaneous presence of (i) hydrophilic segments in an amount of at least 50 wt. %, (ii) hydrophobic segments in an amount of at most 10 wt. % and (iii) urethane groups. The term “hydrophilic segments” is understood to mean in particular polyurethane chains with at least 5 chain members whose alkylene oxide units contain at least up to 60 mole % of ethylene oxide units. The term “hydrophobic segments” is understood to mean in particular hydrocarbons segments with at least 6 carbon atoms that are incorporated within the chain and/or are preferably incorporated in the terminal position.

The thickening agents according to the invention described hereinafter also preferably correspond to this definition.

These polyurethane thickening agents are suitable as auxiliary substances for adjusting the rheological properties of aqueous systems, such as automotive and industrial paints, plaster paints and building coating compounds, printing inks and textile dyes, pigment printing pastes, pharmaceutical and cosmetic preparations, plant protection formulations, detergent preparations or filler dispersions and adhesive dispersions.

Although the known polyurethane thickeners have a broad range of applications, for many areas of use they have a too low thickening action in the low-shear range. As a result, they either have to be used in relatively high concentrations or other measures have to be adopted in order to increase the viscosity, such as increasing the pigment and/or solids concentration. In such cases undesirable changes may however arise in the application technology properties of the produced paints or other preparations, such as in the flow, hardening behaviour, gloss or covering power.

Another possible way of increasing the low-shear viscosity is to use thickeners based on cellulose or polyacrylates. However, these products have serious disadvantages, such as reduced compatibility in the coating or impaired flow and gloss.

It is an objective of the present invention to develop improved thickening agents for aqueous systems for use in the low-shear range.

This object was achieved by the hydrophilic/hydrophobic water-soluble or water-dispersible polyurethanes according to the invention described in more detail hereinafter. The essential feature of the invention is the use of urethane group-containing polyether polyols having an average functionality of ≧4, optionally mixed with other polyether polyols, as described hereinafter.

### SUMMARY OF THE INVENTION

The present invention relates to a water-soluble or water-dispersible polyurethanes containing a reaction product of

A) at least one polyether polyol a1) having an average functionality of ≧3 and at least one urethane group-containing polyether polyol a2) having an average functionality of ≧4,

B) at least one monoisocyanate having 8 to 22 carbon atoms,

C) at least one (cyclo)aliphatic and/or aromatic diisocyanate,

D) optionally at least one monoalcohol having 8 to 22 carbon atoms, and

E) optionally at least one polyisocyanate having an average functionality of >2

The present invention also relates to a process for the production of these water-soluble or water-dispersible polyurethanes by reacting in a one-stage or multi-stage reaction at a starting NCO/OH equivalent ratio of 0.5:1 to 1.2:1,

A) a mixture of at least one polyether polyol a1) having an average functionality of ≧3 and at least 1 urethane group-containing polyether polyol a2) having an average functionality of ≧4,

B) at least one monoisocyanate having 8 to 22 carbon atoms,

C) at least one (cyclo)aliphatic and/or aromatic diisocyanate,

D) optionally at least one monoalcohol having 8 to 22 carbon atoms, and

E) optionally at least one polyisocyanate having an average functionality of >2.

### DETAILED DESCRIPTION OF THE INVENTION

In the production according to the invention the urethane group-containing polyether polyol a2) may be produced by partial reaction of the polyether polyol a1) with a diisocyanate.

In a further production variant the urethane group-containing polyether polyol a2) may be produced by partial reaction of the polyether polyol a1) with polyisocyanates having an average functionality of ≧2.

The present invention also provides for the use of the polyurethanes according to the invention for thickening aqueous systems.

Polyether polyol component A) contains at least one polyether polyol a1) of formula (I)

R₁[—O—(A)ₓH]_{y} (I),

wherein

R₁ represents an aliphatic or araliphatic hydrocarbon radical with 4 to 36 carbon atoms and optionally having ether oxygen atoms,

A represents an ethylene oxide and/or propylene oxide radical with the proviso that at least 50 mole %, preferably 70 mole % and more preferably 100 mole % of the radicals represent ethylene oxide radicals,

x represents a number from 30 to 250, and preferably 30 to 150

y represents a number from 3 to 18, preferably 3 to 6,

and a urethane group-containing polyether polyol a2) of formula (II)

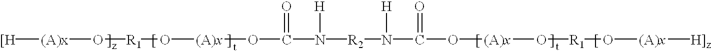

wherein

R₁ represents an aliphatic or araliphatic hydrocarbon radical with 4 to 36 carbon atoms optionally containing ether oxygen atoms,

R₂ represents an aliphatic, araliphatic, cycloaliphatic or aromatic radical with 4 to 12 carbon atoms,

A represents ethylene oxide and/or propylene oxide radicals with the proviso that at least 50 mole %, preferably 70 mole % and more preferably 100 mole % of the radicals denote ethylene oxide radicals,

x represents a number from 30 to 250, preferably 30 to 150 and

z represents a number from 2 to 16, preferably 2, 3 or4, and t=(y−z).

The monoisocyanate component B) contains at least one monoisocyanate of formula (III)

R₃—NCO (III),

wherein

R₃ represents an aliphatic, cycloaliphatic, aromatic or araliphatic hydrocarbon radical with 8 to 22, preferably 10 to 18 and more preferably 12 to 18 carbon atoms, and optionally contains inert substituents.

Component C) contains of at least one diisocyanate of the general formula (IV)

OCN—R₄—NCO (IV),

wherein

R₄ represents an aliphatic, araliphatic, cycloaliphatic or aromatic radical with 4 to 22 carbon atoms and optionally contains inert substituents.

Component D) contains at least one monoalcohol of formula (V)

R₃—OH (V),

wherein

R₃ has the meaning given for formula (III).

The component E) contains at least one aliphatic, araliphatic, cycloaliphatic, heterocyclic or aromatic polyisocyanate having a functionality of >2.

The production of the base polyether a1) on which the mixture of the polyether alcohols A) is based is carried out in a known manner by alkoxylation of corresponding polyhydric alcohols of formula (VI)

R¹—[—OH]_{y} (VI),

wherein

R¹ and y have the meaning given for formula (I), using ethylene oxide and optionally propylene oxide in a mixture and/or arbitrary sequence. Suitable initiators include glycerol, trimethylolpropane, trimethylolethane, pentaerythritol, di-trimethylolpropane, sorbitol, sugars, etc. Glycerol, trimethylolpropane and sorbitol are preferably used, and glycerol and sorbitol are more preferably used.

The production of the polyether alcohol mixture A) containing polyether a1) and the urethane group-containing polyether a2) is carried out by the partial reaction of the polyethers a1) with at least one organic isocyanate having a functionality of ≧2. In this context up to 50 mole %, preferably up to 20 mole % and more preferably up to 10 mole % of the polyethers a1) may be reacted with isocyanates. The reaction is carried out in a temperature range from 0° to 180° C., preferably 200 to 160° C. and more preferably 600 to 120° C.

Examples of the monoisocyanate component B) include aliphatic monoisocyanates such as 1-octyl isocyanate, 1-nonyl isocyanate, 1-decyl isocyanate, 1-dodecyl isocyanate, 1-octadecyl isocyanate, etc. Preferred are isocyanates with 10 to 18 carbon atoms, monoisocyanates with 12 to 18 carbon atoms being more preferred.

Examples of diisocyanates of component C) include aliphatic diisocyanates such as 1,4-butane diisocyanate or 1,6-hexane diisocyanate; cycloaliphatic diisocyanates such as 1-isocyanato-3,3,5-trimethyl-5-isocyanatomethyl-cyclohexane (isophorone diisocyanate), 1,3- and 1,4-cyclohexane diisocyanate, 4,4′-diisocyanatodicyclohexyl-methane, etc., as well as aromatic diisocyanates such as 2,4-diisocyanatotoluene and 4,4′-diisocyanatodiphenylmethane.

Examples of monoalcohol component D) include aliphatic alcohols such as 1-octanol, 2-ethylhexanol, 1-nonanol, 1-decanol, 1-dodecanol, 1-tetradecanol, 1-hexadecanol, 1-octadecanol, 1-docosanol, etc. Monoalcohols with 10 to 18 carbon atoms are preferred, monoalcohols with 12 to 18 carbon atoms being more preferred.

Examples of polyisocyanate component E) include commercially available paint polyisocyanates, in other words in particular the known modification products of simple diisocyanates containing urethane groups, uretdione groups, allophanate groups and in particular biuret groups, isocyanurate groups and iminooxadiazine-dione groups, examples of suitable diisocyanates being 1,6-diisocyanatohexane, 1-isocyanato-3,3,5-trimethyl-5-isocyanatomethylcyclohexane (isophorone diisocyanate), 4,4′-diisocyanatodicyclohexylmethane, 1,4-diisocyanatocyclohexane, 1-methyl-2,4-diisocyanatocyclohexane and its mixtures with up to 35 wt. %, referred to the total mixture, of 1-methyl-2,6-diisocyanatocyclohexane; 2,4-diisocyanato-toluene and its mixtures with up to 35 wt. %, referred to the total mixture of 2,6-diisocyanototoluene or its mixtures. More preferably used are the corresponding “paint polyisocyanates” with aliphatically and/or cycloaliphatically bound, free isocyanate groups. A suitable polyisocyanate that does not contain the aforementioned groupings is 4-isocyanatomethyl-1,8-octane diisocyanate.

Paint polyisocyanates containing urethane groups include for example the reaction products of 2,4- and optionally 2,6-diisocyanatotoluene or 1-methyl-2,4-diisocyanatocyclohexane and optionally 1-methyl-2,6-diisocyanatocyclohexane with sub-stoichiometric amounts of trimethylolpropane, or their mixtures with simple diols such as the isomeric propanediols or butanediols. The production of such urethane group-containing paint polyisocyanates in practically monomer-free form is described for example in DE-A 1 090 196.

The biuret group-containing paint polyisocyanates that are more preferred for use according to the invention include in particular those based on 1,6-diisocyanatohexane, the production of which is described for example in EP-A 0 003 505, DE-A 1 101 394, U.S. Pat. No. 3,358,010 or U.S. Pat. No. 3,903,127.

The more preferred isocyanurate group-containing paint polyisocyanates include in particular the trimers or mixed trimers of the diisocyanates mentioned above by way of example, such as the isocyanurate group-containing polyisocyanurates based or) diisocyanatotoluene according to GB-A 1 060 430, GB-A 1 506 373 or GB-A 1 485 564, the mixed trimers of diisocyanatotoluene with 1,6-diisocyanatohexane, which may be obtained for example according to DE-A 1644 809 or DE-A 3 144 672, and in particular the aliphatic, aliphatic-cycloaliphatic and cycloaliphatic trimers or mixed trimers based on 1,6-diisocyanatohexane and/or isophorone diisocyanate, which may be obtained for example according to U.S. Pat. No. 4,324,879, U.S. Pat. No. 4,288,586, DE-A 3 100 262, DE-A 3 100 263, DE-A 3 033 860 or DE-A 3 144 672.

The paint polyisocyanates that may be used according to the invention generally have an isocyanate content of 5 to 25 wt. %, an average NCO functionality of 2.1 to 5.0, preferably 2.8 to 4.0, and a residual content, used for their production, of monomeric diisocyanates of less than 2 wt. %, preferably less than 0.5 wt. %. Obviously any appropriate mixtures of the paint polyisocyanates mentioned by way of example may also be used.

The production of the polyurethanes according to the invention is carried out in one or several stages. A one-stage reaction is understood in this context to mean the reaction of the total amount of component a1) with the total amount of components B), C), optionally D) and optionally E). In this connection component A) is formed in situ depending on the chosen amount of component C). A multi-stage reaction contains for example reacting part of component a1) with part of component C), followed by reacting resultant component A) with component B), the remainder of component C) as well as optionally components D) and E). A multi-stage reaction can also consist in reacting polyether a1) with component B) followed by the reaction of this precursor with the total amount of the component C). A multi-stage reaction can also or additionally consist in a separate reaction of part of or the total amount of monoalcohol components D) with a molar excess of diisocyanate components C) followed by reaction of the resulting NCO prepolymer with the previously produced component A) and optionally component E). The sequence of the reactions is in this case largely unimportant, and it only has to be ensured that the component A) according to the above definition can be formed by suitably choosing the amounts to be used of components A) to C) and optionally D) and E).

The polyurethanes according to the invention produced in this way are generally colourless to yellowish waxes or highly viscous polymers having softening points or softening ranges within the temperature range from 10° to 80° C. For subsequent use it is often advantageous to mix the polyurethanes according to the invention with additives, such as formulation agents, solvents, water, emulsifiers or stabilisers, to form liquid formulations.

The polyurethanes according to the invention are suitable for thickening aqueous or predominantly aqueous systems such as paints, leather and paper auxiliary substances, preparations for oil production extraction, detergent and adhesive preparations, waxes for polishes, formulations for pharmaceutical and veterinary purposes, plant protection preparations, cosmetics articles, etc. Also the water itself can be thickened with the polyurethane thickeners according to the invention so that optionally further additives can be added or alternatively the water itself can be added to aqueous preparations. The thickeners according to the invention may also be used in mixtures with other thickening agents, such as those based on polyacrylates, cellulose derivatives or inorganic thickening agents.

Examples of aqueous systems that can be thickened according to the invention include aqueous polyacrylate dispersions, aqueous dispersions of copolymers of olefinically unsaturated monomers, aqueous polyvinyl acetate dispersions, aqueous polyurethane dispersions, aqueous polyesters dispersions and in particular ready-for-use preparations of the type already described above based on such dispersions or mixtures of such dispersions.

The thickening agents according to the invention may obviously be used in bulk, preferably as granules or optionally powders. It is preferred however to use liquid formulations that contain, in addition to the polyurethanes according to the invention, also water, solvents such as butyl diglycol, isopropanol, methoxypropyl acetate, ethylene glycol and/or propylene glycol, non-ionic emulsifiers, surfactants and/or optionally further additives since in this way the incorporation of the thickening agents according to the invention into aqueous or predominantly aqueous systems is substantially facilitated.

The ready-for-use preparations of the thickening agents according to the invention are more preferably aqueous solutions or dispersions having a solids content of 10 to 80, preferably 30 to 60 and more preferably 40 to 50 wt. %.

The amount of thickening agents according to the invention that is added to the aqueous or predominantly aqueous systems in order to achieve the desired thickening effect depends on the intended use and may be determined by the person skilled in the art in a few preliminary experiments. As a rule 0.05 to 10 wt. %, preferably 0.1 to 4 wt. % and more preferably 0.1 to 2 wt. % of the thickening agent according to the invention is used, these percentage figures referring to the solids content of the thickening agent on the one hand and to the solids content of the aqueous system to be thickened on the other hand.

The evaluation of the effectiveness of the thickening agents according to the invention may be carried out by known methods, for example in a Haake rotary viscosimeter, in a Stormer or Brookfield viscosimeter, or in an ICI viscosimeter.

### EXAMPLES

Abbreviations:

DBTL: dibutyltin-IV-dilaurate

Desmorapid SO: tin-II dioctoate

### Raw Materials Used

Polyether a₁):

I Polyether based on glycerol and a mixture of ethylene oxide and propylene oxide (ratio 75:25) and with an OH number of 17.2 mg KOH/g

II Polyether based on glycerol and ethylene oxide with an OH number of 15.2 mg KOH/g

III Polyether based on sorbitol and a mixture of ethylene oxide and propylene oxide (ratio 93.2:6.8) and having an OH number of 18.3 mg KOH/g

### Production of the Polyurethanes According to the Invention

### Example 1

880 g of polyether I were weighed out under nitrogen in a 2 l capacity glass flask and freed within 5 hours at 1 mbar/125° C. from traces of water. 31.0 g of stearyl isocyanate, 5.0 g of hexamethylene diisocyanate and 0.09 g of DBTL were then added, following which the reaction mixture was stirred at 120° C. until isocyanate bands could no longer be detected by IR spectroscopy. 19.6 g of 1-dodecanol were next added and the whole was stirred for 10 minutes at 120° C. 17.6 g of hexamethylene diisocyanate were then added and stirred at 120° C. until isocyanate bands could no longer be detected by IR spectroscopy. A highly viscous, pale yellowish polyurethane resin was formed.

### Example 2

880 g of polyether I were weighed out under nitrogen in a 2 l capacity glass flask and freed within 5 hours at 1 mbar/125° C. from traces of water. 31.0 g of stearyl isocyanate, 6.6 g of isophorone diisocyanate and 0.09 g of DBTL were then added, following which the reaction mixture was stirred at 120° C. until isocyanate bands could no longer be detected by IR spectroscopy. 19.6 g of 1-dodecanol were next added and the whole was stirred for 10 minutes at 120° C. 23.2 g of isophorone diisocyanate were then added and stirred at 120° C. until isocyanate bands could no longer be detected by IR spectroscopy. A highly viscous, pale yellowish polyurethane resin was formed.

### Example 3

821 g of polyether I were weighed under nitrogen out in a 2 l capacity glass flask and freed within 5 hours at 1 mbar/125° C. from traces of water. 29.0 g of stearyl isocyanate, 4.8 g of hexamethylene diisocyanate and 0.09 g of DBTL were then added, following which the reaction mixture was stirred at 120° C. until isocyanate bands could no longer be detected by IR spectroscopy. 26.4 g of stearyl alcohol were next added and the whole was stirred for 10 minutes at 120° C. 21.8 g of isophorone diisocyanate were then added and stirred at 120° C. until isocyanate bands could no longer be detected by IR spectroscopy. A highly viscous, pale yellowish polyurethane resin was formed.

### Example 4

880 g of polyether III were weighed out under nitrogen in a 2 l capacity glass flask and freed within 5 hours at 1 mbar/125° C. from traces of water. 28.4 g of stearyl isocyanate and 0.09 g of DBTL were then added and the whole was stirred at 120° C. until isocyanate bands could no longer be detected by IR spectroscopy. 22.4 g of 1-dodecanol were next added and the whole was stirred for 10 minutes at 120° C. 10.0 g of hexamethylene diisocyanate were then added and the whole was stirred at 120° C. until isocyanate bands could no longer be detected by IR spectroscopy. A further 2.0 g of hexamethylene diisocyanate were then added and the whole was stirred at 120° C. until isocyanate bands could no longer be detected by IR spectroscopy. A highly viscous, pale yellowish polyurethane resin was formed.

### Example 5

991 g of polyether III were weighed out under nitrogen in a 2 l capacity glass flask and freed within 5 hours at 1 mbar/125° C. from traces of water. 63.8 g of stearyl isocyanate and 0.09 g of Desmorapid® SO were next added and the whole was then stirred at 120° C. until isocyanate bands could no longer be detected by IR spectroscopy. 1.5 g of isophorone diisocyanate were next added and the whole was stirred at 120° C. until isocyanate bands could no longer be detected by IR spectroscopy. A highly viscous, pale yellowish polyurethane resin was formed.

### Example 6

991 g of polyether III were weighed out under nitrogen in a 2 l capacity glass flask and freed within 5 hours at 1 mbar/125° C. from traces of water. 63.8 g of stearyl isocyanate and 0.09 g of Desmorapid® SO were next added and the whole was then stirred at 120° C. until isocyanate bands could no longer be detected by IR spectroscopy. 3.0 g of isophorone diisocyanate were next added and the whole was stirred at 120° C. until isocyanate bands could no longer be detected by IR spectroscopy. A highly viscous, pale yellowish polyurethane resin was formed.

### Example 7

1102 g of polyether III were weighed out under nitrogen in a 2 l capacity glass flask and freed within 5 hours at 1 mbar/125° C. from traces of water. 29.6 g of stearyl isocyanate, 21.2 g of dodecyl isocyanate, 3.34 g of hexamethylene diisocyanate and 0.09 g of Desmorapid® SO were next added and the whole was then stirred at 120° C. until isocyanate bands could no longer be detected by IR spectroscopy. A waxy, pale yellowish polyurethane resin was formed.

### Example 8

928 g of polyether II were weighed out under nitrogen in a 2 l capacity glass flask and freed within 5 hours at 1 mbar/125° C. from traces of water. 57.8 g of stearyl isocyanate, 4.8 g of hexamethylene diisocyanate and 0.09 g of Desmorapid SO were next added and the whole was stirred at 120° C. until isocyanate bands could no longer be detected by IR spectroscopy. A waxy, pale yellowish polyurethane resin was formed.

### Example 9

938 g of polyether I were weighed out in a 2 l capacity glass flask and freed within 5 hours at 1 mbar/125° C. from traces of water. 66.0 g of stearyl isocyanate, 5.4 g of hexamethylene diisocyanate and 0.09 g of Desmorapid SO were next added and the whole was stirred at 120° C. until isocyanate bands could no longer be detected by IR spectroscopy. A waxy, pale yellowish polyurethane resin was formed.

The polyurethane thickeners produced in Examples 1 to 9 were made into 60% solutions in water, ¹)Levalin FD and ¹)Emulsifier WN (ratio 3:2:1). ¹) Commercial products from Bayer AG

### Comparison Example 1

Polyurethane thickener analogous to Example 5, but without the use of isophorone diisocyanate:

991 g of polyether III were weighed under nitrogen out in a 2 l capacity glass flask and freed within 5 hours at 1 mbar/125° C. from traces of water. 63.8 g of stearyl isocyanate and 0.09 g of Desmorapid SO were then added and the whole was stirred at 120° C. until isocyanate bands could no longer be detected by IR spectroscopy. A highly viscous, pale yellowish polyurethane resin was formed that was dissolved to form 60% solutions in water, ¹⁾Levalin FD and ¹⁾Emulsifier WN (ratio 3:2:1). ¹⁾Commercial products from Bayer AG

### Comparison Example 2

Polyurethane thickener analogous to Example 7, but without the use of hexamethylene diisocyanate:

1102 g of polyether III were weighed out under nitrogen in a 2 l capacity glass flask and freed within 5 hours at 1 mbar/125° C. from traces of water. 29.6 g of stearyl isocyanate, 21.2 g of dodecyl isocyanate and 0.09 g of Desmorapid® SO were then added and the whole was stirred at 120° C. until isocyanate bands could no longer be detected by IR spectroscopy. A waxy, pale yellowish polyurethane resin was obtained that was dissolved to form 60% solutions in water, ¹⁾Levalin FD and ¹⁾Emulsifier WN (ratio 3:2:1). ¹⁾Commercial products from Bayer AG

### Examples of Use

The following examples show that emulsion paints can be thickened in a highly efficient manner using the thickening agents according to the invention.

Production of the paints and checking the thickening action by viscosity measurement.

The following constituents were dispersed over 30 minutes in a 1000 ml flask equipped with 100 glass beads (Ø3 mm) using a Skandex disperser:

| | | |
|---|---|---|
| AMP (aminopropanol)¹⁾ | 1.25 | g |
| Borchigen ND (25% in H₂O)²⁾ | 6.8 | g |
| Neocryl AP 2860 (20%) defoaming agent³⁾ | 1.6 | g |
| Thickener (50%) | 10.0 | g |
| TiO₂ RHD-2 (Tioxide Company) | 112.5 | g |
| Methoxybutanol | 8.5 | g |
| Propylene glycol | 8.5 | g |
| Butyl diglycol | 8.5 | g |
| H₂O | 22.35 | g |
| then after the addition of H₂O | 50.0 | g |
| Neocryl XK 62 (42%)⁴⁾ | 270.0 | g |
| | 500.0 | g |

¹⁾(2-amino-2-methylpropanol-1, 90% in water), Angus Chemie GmbH, Essen
²⁾Wetting agent, Borchers GmbH, Monheim
³⁾Defoaming agent, ICI Resins, Runcorn, England
⁴⁾Anionic dispersion based on acrylate/styrene, ICI Resins

is dispersed for a further 30 minutes. The paint is then freed from the glass beads. After a maturation time of ca. 12 hours the viscosity measurements were made in the low-shear range at 10.3 s⁻¹ with a Haake VT 500 viscosimeter (measurement body SV DIN).

The test results obtained with regard to the thickening effect are listed in the following Table 1.

TABLE 1
Thickening effect of polyurethane thickeners, characterised by
the resultant paint viscosity

| Thickener Example No. | Viscosity (mPa · s) at D = 10.3 s⁻¹ |
|---|---|
| 1 | 24100 |
| 2 | 25900 |
| 3 | 25600 |
| 4 | 22100 |
| 5 | 35000 |
| 6 | 33250 |
| 7 | 21100 |
| 8 | 24300 |
| 9 | 21500 |
| As comparison: | |
| Acrysol PM 8^{a)} | 6000 |
| Bermodol 2150^{b)} | 6400 |
| Lanco Thix PUR 21^{c)} | 13100 |
| Ser-Ad FX 1010^{d)} | 10700 |
| Borchigel L 75 N^{e)} | 15000 |
| Comparison Example 1 | 20500 (comparison re No. 5) |
| Comparison Example 2 | 15200 (comparison re No. 7) |

^{a)}Rohm & Haas Co.
^{b)}Akzo Nobel
^{c)}Lubrizol Corp.
^{d)}CONDEA Servo BV
^{e)}Borchers GmbH, Monheim

### SUMMARY

The results of the viscosity measurements clearly show the improved thickening effect of the thickening agents according to the invention compared to commercially available products and to the comparison examples.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A water-soluble or water-dispersible polyurethane comprising a reaction product of
A) a mixture of at least one polyether polyol a1) having an average functionality of ≧3 and at least one urethane group-containing polyether polyol a2) having an average functionality of ≧4,
B) at least one monoisocyanate having 8 to 22 carbon atoms,
C) at least one (cyclo)aliphatic and/or aromatic diisocyanate,
D) optionally at least one monoalcohol having 8 to 22 carbon atoms, and
F) optionally at least one polyisocyanate having an average functionality of >2
wherein the starting NCO/OH equivalent ratio is between 0.5:1 to 1.2:1.

2. The polyurethane of claim 1 wherein polyether polyol a1) has an average functionality of 3.

3. The polyurethane of claim 1 wherein polyether polyol a1) has an average functionality of 4 to 6.

4. The polyurethane of claim 1 wherein monoisocyanate B) has 10 to 18 carbon atoms.

5. The polyurethane of claim 1 wherein monoisocyanate B) has 12 to 18 carbon atoms.

6. The polyurethane of claim 1 wherein diisocyanate C) is a (cyclo)aliphatic diisocyanate.

7. The polyurethane of claim 1 wherein monoalcohol D) contains 10 to 18 carbon atoms.

8. A process for the production of a water-soluble or water-dispersible polyurethane comprising reacting
A) a mixture of at least one polyether polyol a1) having an average functionality of ≧3 and at least one urethane group-containing polyether polyol a2) having an average functionality of ≧4,
B) at least one monoisocyanate with 8 to 22 carbon atoms,
C) at least one (cyclo)aliphatic and/or aromatic diisocyanate,
D) optionally at least one monoalcohol with 8 to 22 carbon atoms, and
E) optionally at least one polyisocyanate having a mean functionality of>2
wherein the starting NCO/OH equivalent ratio is between 0.5:1 to 1.2:1.

9. The process of claim 8 wherein the urethane group-containing polyether polyol a2) is produced by partial reaction of the polyether polyol a1) with a diisocyanate.

10. The process of claim 8 wherein the urethane group-containing polyether polyol a2) is produced by partial reaction of the polyether polyol a1) with polyisocyanates having an average functionality of ≧2.

11. A composition of matter comprising the polyurethane of claim 1.

12. The composition of claim 11, wherein the composition is a thickened aqueous paint system, an adhesive or another aqueous formulation.
